(19) United States
(12) Patent Application Publication
(10) Pub. No.: US 2014/0180746 A1
(43) Pub. Date: Jun. 26, 2014

(54) RIDE SHARING CALENDAR ENTRY CLASSIFICATION

(71) Applicant: SAP AG, Walldorf (DE)

(72) Inventors: Jens Lehmann, Sunnyvale, CA (US); Vedran Lerenc, Schoenau (DE); David Sommer, Bruehl (DE)

(73) Assignee: SAP AG, Walldorf (DE)

(21) Appl. No.: 13/722,342

(22) Filed: Dec. 20, 2012

(51) Int. Cl. G06Q 10/10; G06Q 50/30

(52) U.S. Cl. CPC G06Q 10/1093; G06Q 50/30
USPC 705/7.18

(57) ABSTRACT

A time difference between a segment belonging to a multi-segment ride and a ride intent may be calculated. The time difference may be compared to a threshold. If the time difference is less than or equal to the threshold, the ride intent may be marked as a new segment of the multi-segment ride. The parameters of the segment belonging to the multi-segment ride and the ride intent may be specified through electronic calendar entries. The segment belonging to the multi-segment ride may be the first temporal segment of the multi-segment ride.

### BACKGROUND

While driving has many benefits, driving has some drawbacks as well. For example, driving can be expensive because of fuel costs, car maintenance, insurance, etc. With the number of vehicles on the road increasing, traffic has also become a significant problem especially in metropolitan areas. Further, vehicles typically emit CO₂, and many localities have enacted CO₂ emissions reduction strategies with a focus on car emissions. Thus, it would be beneficial to reduce the number of vehicles on the road.

“Carpooling” can reduce the number of vehicles on the road. Carpooling is where two or more people ride together in a single vehicle instead of each driving alone in their own individual vehicle. In a carpooling system, requests for rides may be submitted through electronic calendar entries. Treating each calendar entry as a request for a separate ride may lead to undesired results. Therefore, in certain circumstances, multiple calendar entries may be associated with a multi-segment ride.

### BRIEF DESCRIPTION OF THE DRAWINGS

FIG. 1 is a simplified block diagram of an automated ride scheduling system according to an embodiment of the present invention.

FIG. 2 is a simplified block diagram of a user device according to an embodiment of the present invention.

FIG. 3 illustrates calendar entries specifying ride sharing parameters according to an embodiment.

FIG. 4 illustrates a method to determine whether ride sharing calendar entries are treated as separate rides or segments of a single ride according to an embodiment.

### DETAILED DESCRIPTION

Embodiments may be discussed in systems to efficiently schedule shared rides. In an embodiment, a time difference between a segment belonging to a multi-segment ride and a ride intent may be calculated. The time difference may be compared to a threshold. If the time difference is less than or equal to the threshold, the ride intent may be marked as a new segment of the multi-segment ride. In an embodiment, the parameters of the segment belonging to the multi-segment ride and the ride intent may be specified through electronic calendar entries. In an embodiment, the segment belonging to the multi-segment ride may be the first temporal segment of the multi-segment ride. In an embodiment, prior to the marking, the segment belonging to the multi-segment ride may be the last temporal segment of the multi-segment ride. In an embodiment, the time parameter associated with the ride intent may be a time interval.

In an embodiment, the time difference between a first ride intent and a second ride intent may be calculated. The time difference may be compared to a threshold. If the time difference is less than or equal to the threshold, the first ride intent and the second ride intent may be marked as segments of a multi-segment ride.

FIG. 1 illustrates a simplified block diagram of an automated ride scheduling system 100 according to an embodiment of the present invention. The system 100 may include a plurality of user devices 110.1-110.n that are communicatively coupled via communication link(s) 120 to a central device 130. The communication link(s) 120 may be provided as a computer network or a wireless network such as a cellular network, WLAN network, short range communication network (i.e. BLUETOOTH®) or a combination of different wired and/or wireless networks. For example, the user device 110.1 may initially communicate with a cellular network then thru an IP network to access the central device 130.

The central device 130 may include a communication interface 140, a processing system 150, and a database 160. The communication interface 140 may be compatible with various networks provided by the communication link(s) 120. The processing system 150 may execute a ride sharing application stored thereon. Information associated with the application may be stored in the database 160. The database 160 may be provided as a single database or a combination of multiple databases.

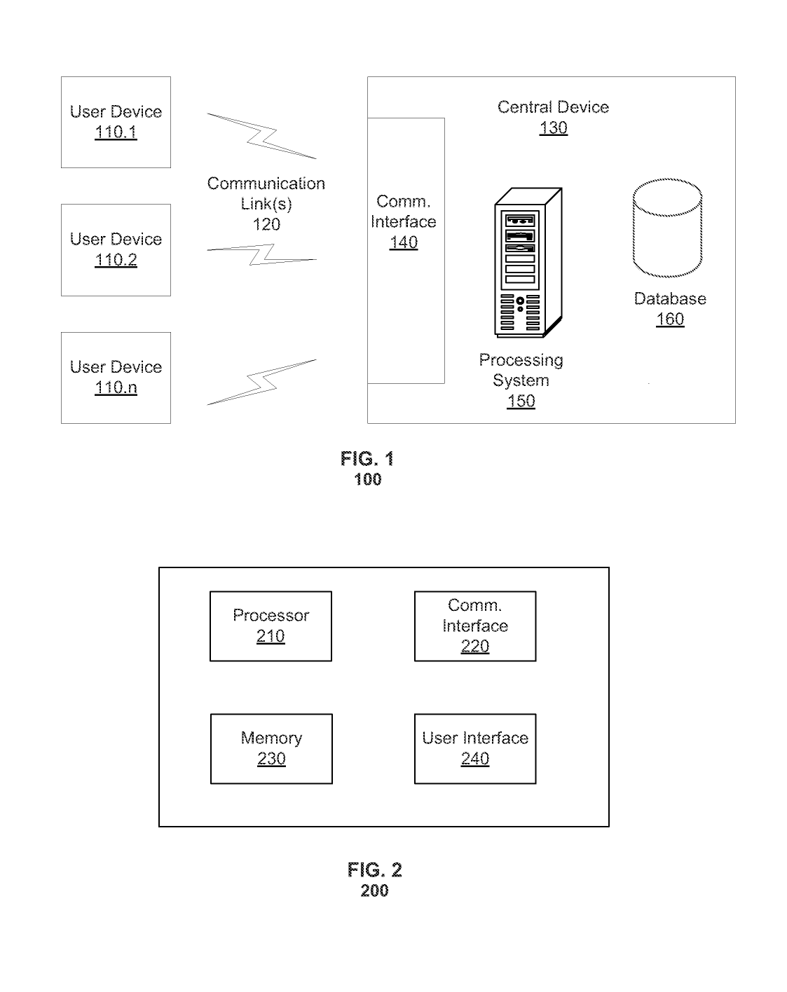

FIG. 2 illustrates a simplified block diagram of a user device 200 according to an embodiment of the present invention. The user device 200 may include a processor 210, a communication interface 210, a memory 230, and a user interface 240. The user device 200 may be provided as a desktop computer, laptop, tablet, pda, cellular phone, vehicle navigation system, or other suitable devices.

The processor 210 may control the operations of the user device 200. The processor 210 may be any of a plurality of conventional processing systems, including microprocessors, digital signal processors, and field programmable logic arrays.

The communications interface 210 may allow the user device to communicate with the central device. The communications interface may be a wireless internet interface, a wired internet interface, cellular network interface, Bluetooth interface, or any suitable communication protocol interface.

The memory 230 may store program instructions as well as other data, for example, ride sharing application data. Memory 230 may include any combination of conventional memory circuits, including, electrical, magnetic, or optical memory systems. For example, memory 230 may include read only memories, random access memories, and bulk storage.

The user interface 240 may include a display screen and input device. The display screen may be, for example, an LCD screen, a CRT, a plasma screen, an LED screen or the like. The input device may be a keyboard, a mouse, touch screen sensors or any other user input device that would allow a user to interact with the user device 200.

A ride sharing application user may specify a set of ride sharing parameters to automatically schedule a ride with one or more other users. The user may specify the parameters through any type of interface on a user device including a web interface, a mobile interface, and/or a stand-alone computer interface. The parameters may include values representing a start location, end location, traveling time, role, detour time, and other preferences such as social compatibility preferences (e.g., gender, age, occupation) and vehicle preferences (e.g., type of music played in the vehicle, temperature within the vehicle, size of the vehicle). The role may represent whether the user prefers to be a driver or a passenger. The detour time may represent the time the user is willing to prolong his ride in order to pick up and drop off passengers. The set of parameters specified by a user for a ride may be referred to as the user's ride intent.

The ride sharing application may receive the user's ride intent and may compare it with ride intents entered by other users. The ride sharing application may then schedule a shared ride between a set of users with matching ride intents. If a threshold number of parameters in a first user's ride intent and a second user's ride intent match, the ride sharing application may determine that the two ride intents match. The ride sharing application may determine that there is match between a parameter of a first user and a corresponding parameter of a second user as long as the values of the parameters are within a tolerance level. For example, the application may determine that there is match between a start location of A and start location of B as long as location A and location B are within a particular distance from each other. Similarly, the application the application may determine that there is match between a vehicle music preference of “classical pop music” and a vehicle music preference of “contemporary pop music” since both match on the pop music aspect. The tolerance level may vary depending on the user and/or the parameter.

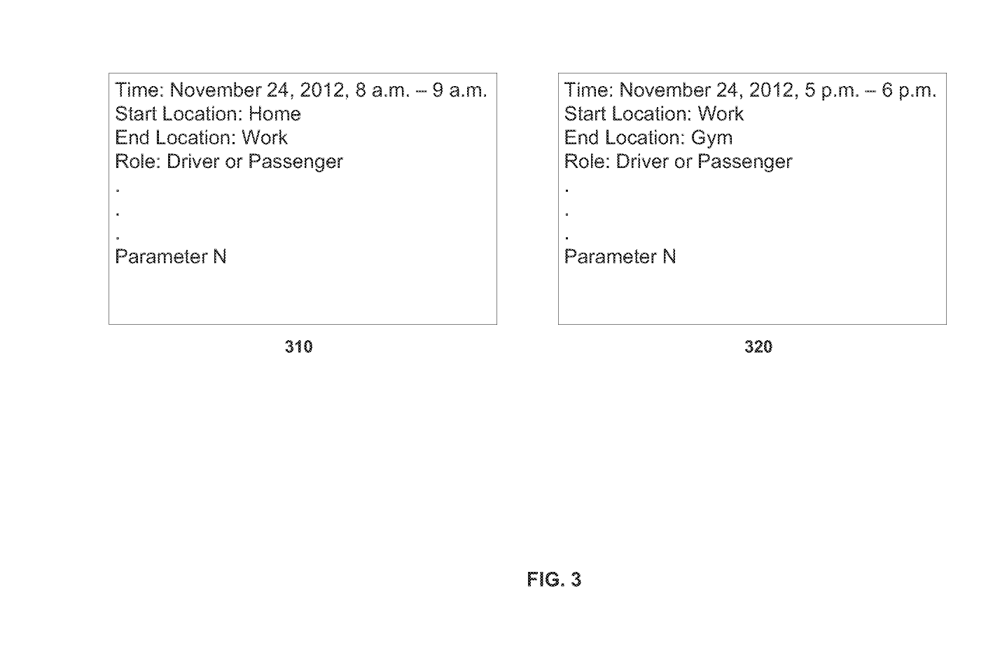

In an embodiment, the user may specify ride intent parameters in an electronic calendar entry. The calendar entry may be created through various file formats including iCalendar and vCalendar. The ride sharing application may extract the parameters in the calendar entry and process the parameters to determine shared rides as discussed above. FIG. 3 illustrates calendar entries specifying ride sharing parameters according to an embodiment. A user may create a calendar entry 310 via an application interface. In the calendar entry 310, the user may specify the time interval for departure, the start location of the ride, the end location of the ride, the role, and other parameters of a ride intent. For example, the user may specify that she would like to depart from home to go to work at any time between 8 a.m. and 9 a.m. on Nov. 24, 2012. In an alternate embodiment, instead of a time interval for departure, the user may specify the time interval for the whole ride. For example, the user may specify that her earliest departure time from home is 8 a.m. and her latest arrival time at work is 9 a.m. Furthermore, the user may specify that she is willing to drive her car or join a ride as a passenger. The ride sharing application may translate the terms “home” and “work” to the corresponding physical addresses based on previously stored information.

Similarly, the user may create a second calendar entry 320 to specify a second set of parameters of a second ride intent. For example, in the calendar entry 320, the user may specify that she would like to depart from work to go to the gym at any time between 5 p.m. and 6 p.m. on Nov. 24, 2012. The user may also specify that she is willing to drive her car or join a ride as a passenger.

Although the calendar entries illustrated in FIG. 3 show the calendar entry information as parameter/value pairs, a person having ordinary skill in the art will appreciate that the user may enter ride information in various other formats as long as the parameters and the values can be extracted from the entered information. For example, in an embodiment, the user may enter a descriptive phrase such as “going to work from home at any time between 8 and 9 a.m.,” and the parameter/value information may be extracted from the descriptive phrase.

If the two calendar entries 310, 320 are treated as two completely separate ride requests, undesirable results may occur. For example, the ride sharing application may schedule a shared ride for the calendar entry 310 where the user's role is “passenger,” but not schedule a shared ride for the calendar entry 320 due to, for example, a lack of vehicles traveling close the “gym” location. The unintended consequence here is that the user may be stranded in the office without a car and therefore may not be able to travel to the gym. In another example, the ride sharing application may schedule a shared ride for the calendar entry 310 where the user's role is “passenger,” and may schedule a shared ride for the calendar entry 320 where the user's role is “driver.” However, this arrangement is not desirable because the user will not have her car at the office if she is a passenger during the shared ride corresponding to calendar entry 310, and therefore will not be able to drive during a shared ride corresponding to calendar entry 320. To avoid such unintended consequences, in an embodiment, the ride sharing application may treat the calendar entry 310 and calendar entry 320 as a request for a single multi-segment ride rather than two unrelated ride requests.

For example, if the ride sharing application treated the calendar entry 310 as a request for the first segment of a multi-segment ride and the calendar entry 320 as a request for the second segment of a multi-segment ride, the ride sharing application may only schedule a shared segment if all segments of the multi-segment ride can be scheduled. Similarly, if the ride sharing application treated the calendar entry 310 and calendar entry 320 as a request for a single multi-segment ride, the ride sharing application may keep the role of the user consistent throughout a corresponding scheduled multi-segment shared ride. Particularly, the ride sharing application may ensure that the user is the driver for all segments or a passenger for all segments.

In an embodiment, a calendar application plugin may implement an option which allows the user to create a multi-segment ride request. However, in certain circumstances where creating a calendar application plugin is not possible/practical, the ride sharing application may have to determine whether standard calendar meeting requests should be treated as separate rides or as segments of a single ride.

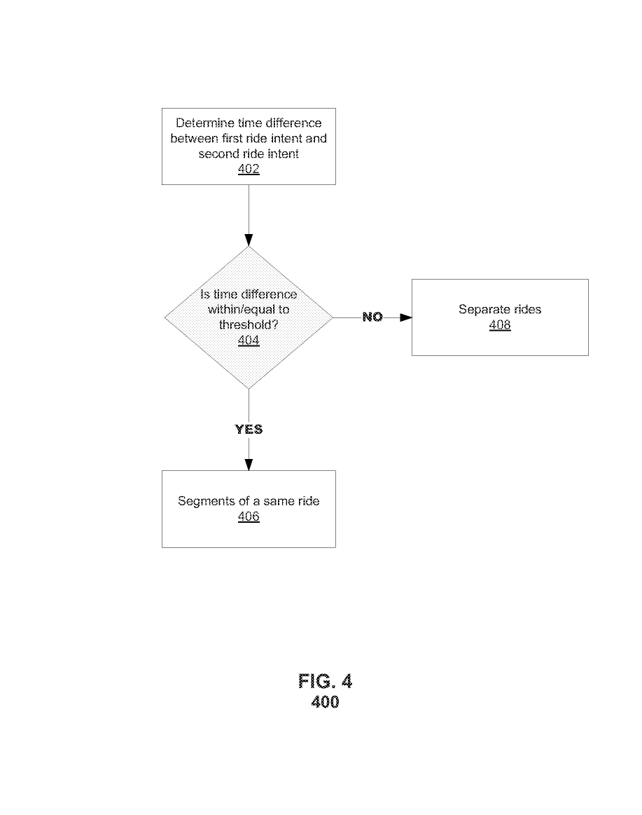

FIG. 4 illustrates a method 400 to determine whether ride sharing calendar entries are treated as separate rides or segments of a single ride according to an embodiment. The method 400 may determine the time difference between the ride intent of a first calendar entry and the ride intent of a second calendar entry 402. If the time difference is within a threshold 404, the method 400 may conclude that the two calendar entries are treated as segments of a single ride 406. Otherwise, the method 400 may conclude that the calendar entries are treated as two separate rides 408.

To determine the time difference between two ride intents, if the respective time parameters of the ride intents specify a single point in time (instead of a time interval), the method 400 may subtract the time parameter of one ride intent from the other. For example, if ride intent A specifies a time of Nov. 24, 2012, 8 a.m., and ride intent B specifies a time of Nov. 24, 2012, 5 p.m., the method may determine that the time difference is nine hours.

If the respective time parameters of the ride intents specify a time interval (instead of a single point in time), the method 400 may use any point of time in the time interval to calculate the time difference. That is, the method 400 may utilize the equation, time difference=(a single point in time within the time interval parameter of the first ride intent)−(a single point in time within the time interval parameter of the second ride intent). For example, if ride intent A specifies a time interval of Nov. 24, 2012, 8 a.m. to 9 a.m., and ride intent B specifies a time interval of Nov. 24, 2012, 5 p.m. to 6 p.m., the method 400 may calculate the time difference between the earliest point in time in the first interval (8 a.m.) and the earliest point in time in the second interval (5 p.m.). In another example, the method 400 may calculate the time difference between the latest point in time in the first interval (9 a.m.) and the latest point in time in the second interval (6 p.m.). In a further example, the method 400 may calculate the time difference between the latest point in time in the first interval (9 a.m.) and the earliest point in time in the second interval (5 p.m.). In another example, the method 400 may calculate the time difference between a mid-point of the first interval (8:30 a.m.) and a mid-point point of the second interval (5:30 p.m.). In a further example, the method 400 may calculate the time difference between the earliest point in time in the first interval (8 a.m.) and the latest point in time in the second interval (6 p.m.). The specific time points within time intervals used by the method 400 to determine the time difference may be a modifiable application and/or user setting. Similarly, the threshold against which the time difference is compared 404 may be a modifiable application and/or user setting.

In an embodiment, the method 400 may determine that a currently processed ride intent belongs to a multi-segment ride if the time difference between the currently processed ride intent and the time associated with the first temporal segment of the multi-segment ride is within the threshold. For example, a multi-segment ride M may include three segments: ride segment A with a corresponding time interval of Nov. 24, 2012, 8 a.m. to 9 a.m., ride segment B with a corresponding time interval of Nov. 24, 2012, 1 p.m. to 1:30 p.m., and ride segment C with a corresponding time interval of Nov. 24, 2012, 3 p.m. to 4 p.m. The method 400 may process a ride intent with a corresponding time interval of Nov. 24, 2012, 5 p.m. to 6 p.m. In this example, the threshold may be 12 hours. Further, to determine the difference between two time intervals, the method 400 may utilize the earliest point in time of the time intervals. Therefore, the method 400 may determine that the time difference between the first temporal segment (i.e., segment A) of the multi-segment ride and the processed ride intent is 9 hours. Since 9 hours is within the threshold of 12 hours, the method 400 may determine that the currently processed ride intent belongs to the multi-segment ride.

In another embodiment, the method 400 may determine that a currently processed ride intent belongs to a multi-segment ride if the time difference between the processed ride intent and the time associated with the last temporal segment of the multi-segment ride is within the threshold. For example, a multi-segment ride M may include three segments: ride segment A with a corresponding time interval of Nov. 24, 2012, 8 a.m. to 9 a.m., ride segment B with a corresponding time interval of Nov. 24, 2012, 1 p.m. to 1:30 p.m., and ride segment C with a corresponding time interval of Nov. 24, 2012, 3 p.m. to 4 p.m. The method 400 may currently process a ride intent with a corresponding time interval of Nov. 25, 2012, 3 a.m. to 4 a.m. In this example, the threshold may be 12 hours. Further, to determine the difference between two time intervals, the method 400 may utilize the earliest point in time of the time intervals. Therefore, the method 400 may determine that the time difference between the last temporal segment (i.e., segment C) of the multi-segment ride and the currently processed ride intent is 12 hours. Since the difference is equal to the threshold, the method 400 may determine that the currently processed ride intent belongs to the multi-segment ride.

A person having ordinary skill in the art will appreciate that although the above methods and examples are illustrated in the context of time intervals pertaining to departure, in other embodiments, the above teachings may be modified to apply to the context of time intervals pertaining to a whole segment and/or ride.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, some of the described embodiments may include software and hardware, but some systems and methods consistent with the present invention may be implemented in software or hardware alone. Additionally, although aspects of the present invention are described as being stored in memory, this may include other computer readable media, such as secondary storage devices, for example, solid state drives, or DVD ROM; the Internet or other propagation medium; or other forms of RAM or ROM.

1. A processor-implemented method comprising:
calculating, by a processor, a time difference between a last temporal segment belonging to a multi-segment ride and a ride intent, wherein the last temporal segment defines a set of ride preferences of a user and the ride intent defines another set of ride preferences of the same user, a start location of the ride intent and an end location of the segment are different, and parameters of at least one of the last temporal segment and the ride intent are specified through electronic calendar entries;
comparing the time difference to a threshold; and
upon determining that the time difference is less than or equal to the threshold, marking the ride intent as a new segment of the multi-segment ride.

2. A processor-implemented method comprising:
calculating, by a processor, a time difference between a segment belonging to a multi-segment ride and a ride intent, wherein the segment defines a set of ride preferences of a user and the ride intent defines another set of ride preferences of the same user, and a start location of the ride intent and an end location of the segment are different;
comparing the time difference to a threshold; and
upon determining that the time difference is less than or equal to the threshold, marking the ride intent as a new segment of the multi-segment ride.

3. The method of claim 2, wherein parameters of at least one of the segment belonging to the multi-segment ride and the ride intent are specified through electronic calendar entries.

4. The method of claim 2, wherein the segment belonging to the multi-segment ride is a first temporal segment of the multi-segment ride.

5. The method of claim 2, wherein, prior to the marking, the segment belonging to the multi-segment ride is a last temporal segment of the multi-segment ride.

6. The method of claim 2, wherein a time parameter associated with the ride intent is a time interval.

7. A processor-implemented method comprising:
calculating, by a processor, a time difference between a first ride intent and a second ride intent, wherein the first ride intent defines a set of ride preferences of a user and the second ride intent defines another set of ride preferences of the same user, and a start location of the first ride intent and an end location of the second ride intent are different;
comparing the time difference to a threshold; and
upon determining that the time difference is less than or equal to the threshold, marking the first ride intent and the second ride intent as segments of a multi-segment ride.

8. An apparatus comprising:
a processor to:
calculate a time difference between a segment belonging to a multi-segment ride and a ride intent, wherein the segment defines a set of ride preferences of a user and the ride intent defines another set of ride preferences of the same user, and a start location of the ride intent and an end location of the segment are different;
compare the time difference to a threshold; and
upon determining that the time difference is less than or equal to the threshold, mark the ride intent as a new segment of the multi-segment ride.

9. The apparatus of claim 8, wherein parameters of at least one of the segment belonging to the multi-segment ride and the ride intent are specified through electronic calendar entries.

10. The apparatus of claim 8, wherein the segment belonging to the multi-segment ride is a first temporal segment of the multi-segment ride.

11. The apparatus of claim 8, wherein, prior to the marking, the segment belonging to the multi-segment ride is a last temporal segment of the multi-segment ride.

12. The apparatus of claim 8, wherein a time parameter associated with the ride intent is a time interval.

13. An apparatus comprising:
a processor to:
calculate a time difference between a first ride intent and a second ride intent, wherein the first ride intent defines a set of ride preferences of a user and the second ride intent defines another set of ride preferences of the same user, and a start location of the first ride intent and an end location of the second ride intent are different;
compare the time difference to a threshold; and
upon determining that the time difference is less than or equal to the threshold, mark the first ride intent and the second ride intent as segments of a multi-segment ride.

14. A non-transitory computer-readable medium embodied with computer-executable instructions for causing a computer to execute instructions, the computer instructions comprising:
calculating a time difference between a segment belonging to a multi-segment ride and a ride intent, wherein the segment defines a set of ride preferences of a user and the ride intent defines another set of ride preferences of the same user, and a start location of the ride intent and an end location of the segment are different;
comparing the time difference to a threshold; and
upon determining that the time difference is less than or equal to the threshold, marking the ride intent as a new segment of the multi-segment ride.

15. The medium of claim 14, wherein parameters of at least one of the segment belonging to the multi-segment ride and the ride intent are specified through electronic calendar entries.

16. The medium of claim 14, wherein the segment belonging to the multi-segment ride is a first temporal segment of the multi-segment ride.

17. The medium of claim 14, wherein, prior to the marking, the segment belonging to the multi-segment ride is a last temporal segment of the multi-segment ride.

18. The medium of claim 14, wherein a time parameter associated with the ride intent is a time interval.

19. A non-transitory computer-readable medium embodied with computer-executable instructions for causing a computer to execute instructions, the computer instructions comprising:
calculating a time difference between a first ride intent and a second ride intent, wherein the first ride intent defines a set of ride preferences of a user and the second ride intent defines another set of ride preferences of the same user, and a start location of the first ride intent and an end location of the second ride intent are different;
comparing the time difference to a threshold; and
upon determining that the time difference is less than or equal to the threshold, marking the first ride intent and the second ride intent as segments of a multi-segment ride.

20. The method of claim 2, wherein after marking the ride intent as the new segment of the multi-segment ride, the multi-segment ride includes at least three segments and each segment of the multi-segment ride defines a respective set of ride preferences of the same user.

21. The method of claim 20, wherein a same driving role is assigned to the user during the each segment of the multi-segment ride and the driving role is one of passenger and driver.

22. The method of claim 2, wherein the calculation of the time difference includes:
determining an earliest time of a time interval associated with the ride intent;
determining an earliest time of a time interval associated with the segment; and
calculating a difference between the ride intent's earliest time and the segment's earliest time.
